(19) United States
(12) Patent Application Publication
(10) Pub. No.: US 2019/0375119 A1
(43) Pub. Date: Dec. 12, 2019

(54) INDEX ASSEMBLY

(71) Applicant: HONG JIN INDUSTRY CO.,LTD., Taichung City (TW)

(72) Inventor: Chung Tsai, Taichung City (TW)

(21) Appl. No.: 16/001,902

(22) Filed: Jun. 6, 2018

(51) Int. Cl. B26B 13/22; B26B 29/06; B26D 1/30; G01B 3/00

(52) U.S. Cl. CPC B26B 13/22; B26B 29/06; B26D 2001/0066; G01B 3/004; B26D 1/30

(57) ABSTRACT

A cutter-used index assembly includes a cutting board, a pointer and at least one spring-biased detent. The cutting board includes at least one group of positioning bores and at least one groove in communication with the positioning bores. The groove is made with a diameter smaller than that of the positioning bores. The pointer is pivotally connected to the cutting board and includes at least one pointing tip. The pointing tip includes an aperture. The aperture includes an upper open end and a reduced lower open end. The at least one spring-biased detent includes comprising a ball inserted in the aperture and formed with a lower portion located out of the aperture. The lower portion of the ball is smoothly movable into one of the positioning bores from another along the groove.

### BACKGROUND OF INVENTION

### 1. Field of Invention

The present invention relates to a cutter and, more particularly, to an index assembly used in a cutter.

### 2. Related Prior Art

There are various cutters. A type of cutters includes two handles, a blade, a cutting board and an index assembly. The handles are pivotally connected to each other. The blade is connected to one of the handles. The cutting board is connected to the other handle. The index assembly includes at least one scale made on or in an upper face of the cutting board and at least one pointing tip rotationally connected to the cutting board. The rotation of the at least one pointing tip relative to the cutting board is not smooth.

The present invention is therefore intended to obviate or at least alleviate the problems encountered in prior art.

### SUMMARY OF INVENTION

It is an objective of the present invention to provide a cutter with a simple and convenient index assembly.

To achieve the foregoing objective, the cutter-used index assembly includes a cutting board, a pointer and at least one spring-biased detent. The cutting board includes at least one group of positioning bores and at least one groove in communication with the positioning bores. The groove is made with a diameter smaller than that of the positioning bores. The pointer is pivotally connected to the cutting board and includes at least one pointing tip. The pointing tip includes an aperture. The aperture includes an upper open end and a reduced lower open end. The at least one spring-biased detent includes comprising a ball inserted in the aperture and formed with a lower portion located out of the aperture. The lower portion of the ball is smoothly movable into one of the positioning bores from another along the groove.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cutter including an index assembly according to the preferred embodiment of the present invention;

FIG. 2 is an exploded view of the index assembly shown in FIG. 1;

FIG. 3 is a perspective view of a cutting board of the index assembly shown in FIG. 2;

FIG. 4 is a bottom view of the index assembly shown in FIG. 2;

FIG. 5 is a cross-sectional view of the index assembly of FIG. 2; and

FIG. 6 is an enlarged partial view of the index assembly of FIG. 5.

### DETAILED DESCRIPTION OF PREFERRED EMBODIMENT

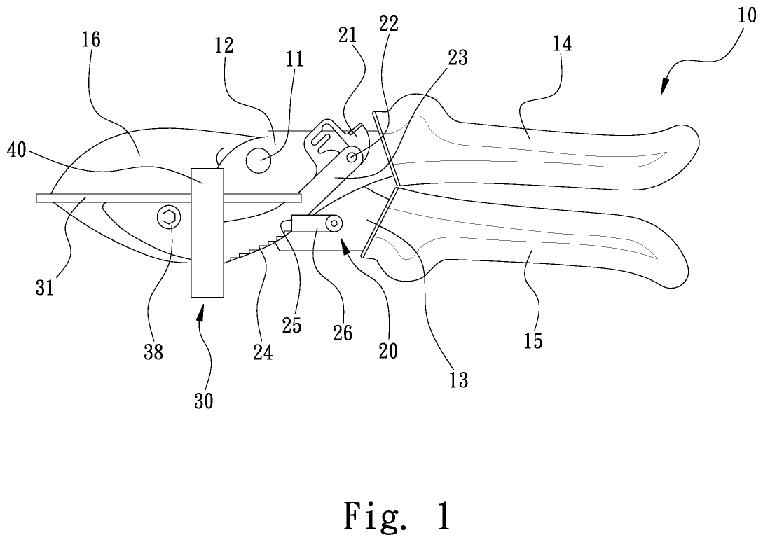

Referring to FIG. 1, a cutter 10 is provided with an index assembly 30 according to the preferred embodiment of the present invention. The cutter 10 will be described before the index assembly 30 is described in detail.

The cutter 10 includes a first handle 12, a second handle 13, two grips 14 and 15 and a blade 16. Preferably, the first handle 12 includes two lateral portions between which a portion of the second handle 13 is located. An axle 11 such as a rivet is used to pivotally connect the first handle 12 to the second handle 13. Of course, in the cutter 10, the position of the first handle 12 can be exchanged with that of the second handle 13. The index assembly 30 is connected to the first handle 12. The grip 14 is provided on the first handle 12, opposite to the index assembly 30. The blade 16 is connected to the second handle 13. The grip 15 is provided on the second handle 13, opposite to the blade 16. The grips 14 and 15 can be closed to pivot the index assembly 30 toward the blade 16. The grips 14 and 15 can be opened to pivot the index assembly 30 from the blade 16.

The cutter 10 further includes a restraining mechanism 20 that includes a releasing lever 21, a ratchet 23 and a pawl 26. The ratchet 23 includes teeth 24 and a recess 25 at a lower edge thereof. The teeth are preferably ratchet teeth. The ratchet 23 is connected to the first handle 12 by two fasteners 22 such as rivets and threaded bolts. The lower edge of the ratchet 23 extends substantially parallel to that of the first handle 12 so that the teeth 24 are arranged substantially along the lower edge of the first handle 12. The releasing lever 21 is located between the first handle 12 and the ratchet 23. The releasing lever 21 is pivotally connected to the first handle 12 by one of the fasteners 22. The releasing lever 21 includes a recess (not shown) corresponding to the recess 25 of the ratchet 23. The pawl 26 is pivotally connected to the second handle 13. The pawl 26 is spring-biased. Thus, the pawl 26 tends to engage with one of the teeth 24 to keep the first handle 12 in an angle relative to the second handle 13. The pawl 26 can be inserted in the recess of the releasing lever 21 and the recess 25 of the ratchet 23, thereby keeping the grips 14 and 15 closed.

The grips 14 and 15 can be opened to release the pawl 26 from the recess 25 and pivot the first handle 12 from the second handle 13. Then, the grips 14 and 15 can be closed to reduce the angle between the first and second handles 12 and 13. Accordingly, the pawl 26 rattles on and moves over the teeth 24 when the grips 14 and 15 are closed. Thus, the pawl 26 is engaged with a desired one of the teeth 24 to retain the first handle 12 at a desired angle relative to the second handle 13. The first handle 12 can only be moved from the second handle 13 when the releasing lever 21 is operated to disengage the pawl 26 from the ratchet 23.

The index assembly 30 is supported on the cutter 10. A work piece (not shown) is laid on the index assembly 30 before the cutter 10 is operated to cut the work piece.

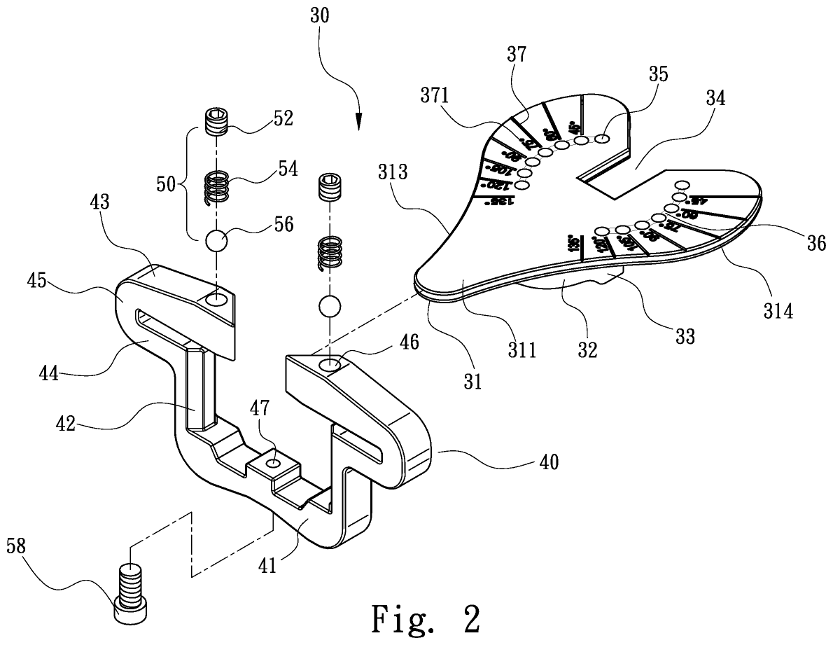

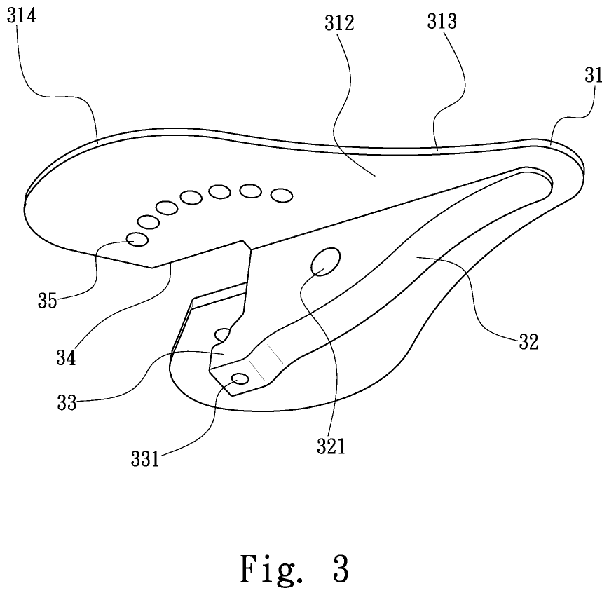

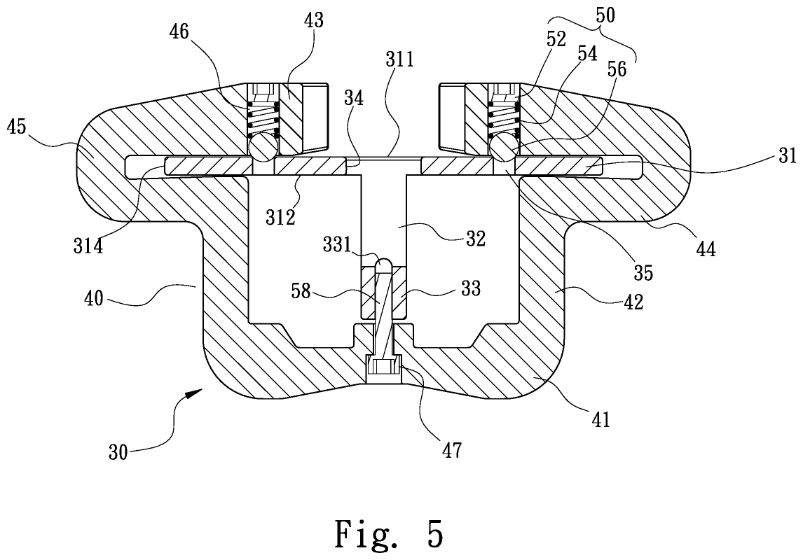

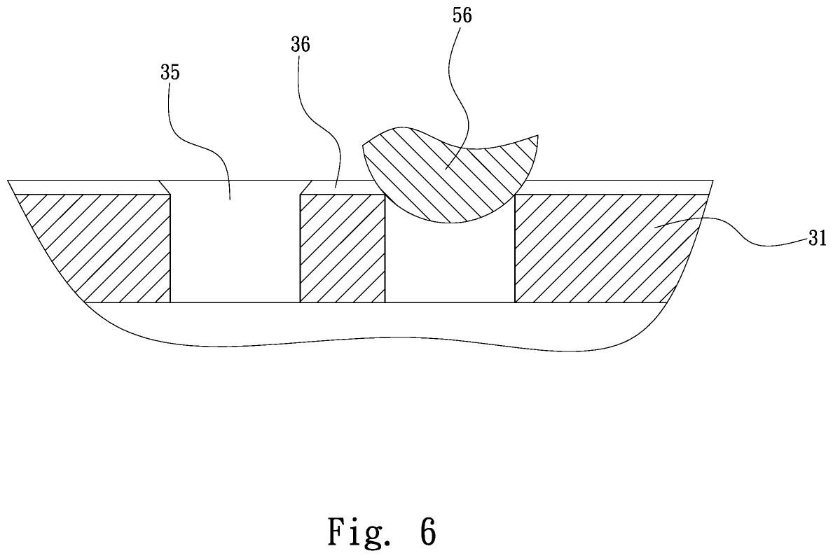

Referring to FIGS. 2 through 6, the index assembly 30 includes a cutting board 31, a pointer 40 and two spring-biased detents 50. The cutting board 31 includes two concave edges 313 near a front end thereof, two convex edges 314 near a rear end thereof, and a cutout 34 at the rear end thereof. Each of the concave edges 313 is connected to a corresponding one of the convex edges 314. The cutout 34 is located between the convex edges 314. The cutting board 31 gets wider toward the rear end.

The cutting board 31 further includes two groups of positioning bores 35 and two grooves 36. The cutout 34 is located between the groups of positioning bores 35. Each of the positioning bores 35 extends throughout the cutting board 31, i.e., from an upper face 311 to a lower face 312. The grooves 36 are made in the upper face 311 of the cutting board 31. Each of the grooves 36 is in communication with each of the positioning bores 35 of a corresponding group. The grooves 36 are made with a diameter smaller than that of the positioning bores 35.

Two scales 37 are made on or in the upper face 311 of the cutting board 31. Like each group of the positioning bores 35, each of the scales 37 is arranged along a corresponding one of the convex edges 314. Each of the scales 37 includes a group of symbols 371. The symbols 371 of each group represent 45°, 60°, 75°, 90°, 105°, 120° and 135°.

The cutting board 31 further includes a fin 32 extending from the lower face 312 thereof and an extension 33 extending from a rear edge of the fin 32. The fin 32 includes a cavity 321 in a lateral face. The extension 33 is located below the cutout 34. The extension 33 includes a bore 331 in a lower face thereof.

In assembly, the fin 32 is located in the lateral portions of the first handle 12 (FIG. 1). The cutout 34 of the cutting board 31 receives the lateral portions of the first handle 12. Another fastener 38 is inserted in the cavity 321 via the first handle 12, hereby connecting the cutting board 31 to the first handle 12 so that the cutting board 31 is not movable relative to the first handle 12.

The pointer 40 includes a primary beam 41, two stems 42, two pointing tips 43, and two secondary beams 44. The primary beam 41 includes a central aperture 47 between two sections thereof. An axle 58 is inserted in the bore 331 through the central aperture 47 to pivotally connect the primary beam 41 to the fin 32. The axle 58 is preferably a threaded bolt, and the bore 331 is hence a screw hole. Each of the stems 42 extends upward from a corresponding one of the sections of the primary beam 41. Each of the secondary beams 44 extends outward from a corresponding one of the stems 42. Each of the pointing tips 43 is connected to a corresponding one of the secondary beams 44 via an arched connective portion 45.

In assembly, the primary beam 41 is located below the cutting board 31. Each of the convex edges 314 is inserted in a corresponding one of the connective portion 45. That is, each of the convex edges 314 is located between a corresponding one of the pointing tips 43 and a corresponding one of the secondary beams 44. The pointing tips 43 are located above the cutting board 31. Each of the pointing tips 43 is movable relative to a corresponding one of the scales 37.

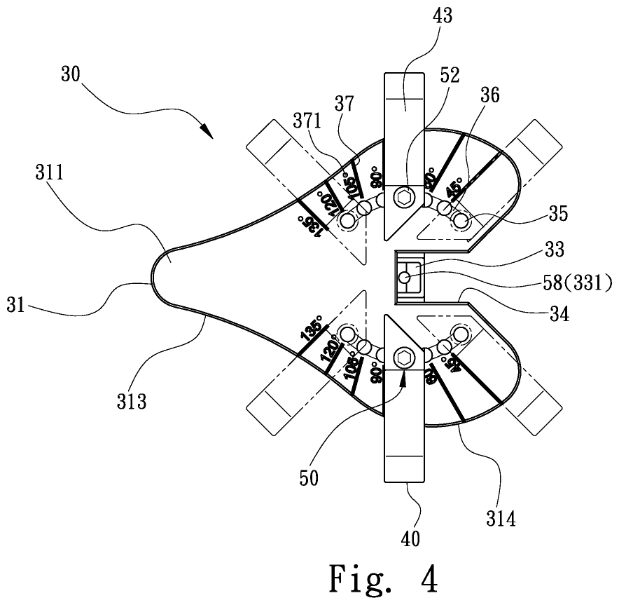

Each of the pointing tips 43 includes an aperture 46 for receiving a corresponding one of the spring-biased detents 50. The aperture 46 includes a lower open end and an upper open end. The diameter of the lower open end is smaller than the upper open end. For briefness, the following description will be given to only one pointing tip 43 and spring-biased detent 50. The spring-biased detent 50 includes a threaded bolt 52, a spring 54 and a ball 56. The ball 56 is inserted in the aperture 46 so that a lower portion of the ball 56 is located out of the aperture 46 via the lower open end of the aperture 46. The spring 54 and the threaded bolt 52 are inserted in the aperture 46 via the upper open end of the aperture 46. The spring 54 is compressed between the ball 56 and the threaded bolt 52, and the lower portion of the ball 56 is retained out of the aperture 46 by the spring 54. The lower portion of the ball 56 is inserted in a selected one of the positioning bores 35 of a corresponding group to keep the pointer 40 in a desired angle relative to the cutting board 31. For example, referring to FIG. 4, the pointer 40 can be kept at 90° indicated by solid lines or 45° or 135° indicated by phantom lines.

The ball 56 is moved to one positioning bore 35 from another along a corresponding one of the grooves 36. Thus, the movement of the ball 56 on the cutting board 31 is smooth, and so is the rotation of the pointer 40 relative to the cutting board 31.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A cutter-used index assembly comprising:
a cutting board (31) comprising at least one group of positioning bores (35) and at least one groove (36) in communication with the positioning bores (35), wherein the groove (36) is made with a diameter smaller than that of the positioning bores (35);
a pointer (40) pivotally connected to the cutting board (31) and formed with at least one pointing tip (43) comprising an aperture (46) made with an upper open end and a reduced lower open end;
at least one spring-biased detent (50) comprising a ball (56) inserted in the aperture (46) and formed with a lower portion located out of the aperture (46), wherein the lower portion of the ball (56) is smoothly movable into one of the positioning bores (35) from another along the groove (36).

2. The index assembly according to claim 1, wherein the cutting board (31) comprises a fin (32) extending from a lower face (312), wherein the pointer (40) comprises a primary beam (41) pivotally connected to the fin (32), at least one stem (42) extending from the primary beam (41), at least one secondary beam (44) extending from the at least one stem (42), wherein the at least one pointing tip (43) extends from the at last one secondary beam (44).

3. The index assembly according to claim 2, wherein the cutting board (31) further comprises an extension (33) extending rearward from the fin (32), wherein the primary beam (41) is pivotally connected to the extension (33).

4. The index assembly according to claim 3, further comprising an axle (58) inserted in the extension (33) through the pointer (40).

5. The index assembly according to claim 2, wherein the cutting board (31) comprises at least one scale (37) on an upper face (311) and at least one group of symbols (371) along the scale (37), wherein each of the symbols (371) represents an angle.

6. The index plate according to claim 1, wherein the at least one spring-biased detent (50) further comprises a spring (54) inserted in the aperture (46) through the upper open end of the aperture (46) and a threaded bolt (52) inserted in the aperture (46) via the upper open end of the aperture (46) so that the spring (54) keeps the lower portion of the ball (56) out of the aperture (46) against the threaded bolt (52).
